(19) United States
(12) Patent Application Publication
(10) Pub. No.: US 2016/0035248 A1
(43) Pub. Date: Feb. 4, 2016

(54) Providing Food-Portion Recommendations to Facilitate Dieting

(71) Applicant: SCIENCESTYLE CAPITAL PARTNERS, LLC, Palm Springs, CA (US)

(72) Inventor: Andrew H. Gibbs, Palm Springs, CA (US)

(21) Appl. No.: 14/774,552

(22) PCT Filed: Mar. 13, 2014
(86) PCT No.: PCT/US14/26266

§ 371 Date: Sep. 10, 2015

Related U.S. Application Data
(60) Provisional application No. 61/782,535, filed on Mar. 14, 2013.

(51) Int. Cl. G09B 19/00; G09B 5/02

(52) U.S. Cl. CPC G09B 19/0092; G09B 5/02

(57) ABSTRACT

The system provides dietary and nutritional information, such as portion-size recommendations, portion-selection guidance, and portion-selection feedback includes various components. For instance, a request for dietary and nutritional information of a food item is received and an image is obtained that depicts the food item. A recommended portion size is determined based on various factors, such as food caloric value and a user profile. Based on the recommended portion size, a visual indicia or graphic is created that overlays the image when the image is displayed on a client device (e.g., smart phone, tablet, laptop, desktop, and the like) and that visual indicates how much of the food item in the image is recommended to be consumed. Other information can also be provided, such as alternative-food recommendations, interactive avatar feedback, and feedback as to how a portion selection compares to a group of users.

### CROSS REFERENCE TO RELATED APPLICATIONS

I hereby claim benefit under Title 35, United States Code, Section 119(e) of U.S. provisional patent application Ser. No. 61/782,535 filed Mar. 14, 2013. The 61/782,535 application is currently abandoned. The 61/782,535 application is hereby incorporated by reference into this application.

This application is a continuation of International Application No. PCT/US2014/026266, filed Mar. 13, 2014, which is a continuation of U.S. Provisional Application No. 61/782,535, filed Mar. 14, 2013. The PCT/US2014/026266 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates to the field of weight loss, weight management, and healthy eating, and more specifically to providing visual aids in real time or near real time that assist with portion control.

2. Description of the Related Art

Any discussion of the related art throughout the specification should in no way be considered as an admission that such related art is widely known or forms part of common general knowledge in the field.

The US Center for Disease Control estimates that more than 35 percent of US adults are obese. Market research shows that at any given time, more than 100 million adults in the United States are dieting to lose weight.

The diet industry is generally comprised of four major segments, including: (a) medically-supervised weight loss/diet programs; (b) do-it-yourself and commercially operated diet programs (e.g., Weight Watchers® and Jenny Craig® systems; (c) over-the-counter (OTC) nutritional and diet supplement products; and (d) food-portion-control products and systems.

It has been shown through numerous clinical and commercially administered studies that three major contributors correlate positively to successful long-term weight loss, including nutrition, exercise, and psychological support. Nutrition includes caloric restriction, portion control, proper foods, and meals consisting of properly balanced food groups. Exercise might provide some physiological benefits, and is also an endorphin stimulator, providing the dieter with a positive feeling. Psychological support includes technical diet management counseling, encouragement, and long-term behavior modification.

The body of work relating to portion control is broad and deep. Many attempts to create devices to control portions have been pursued, resulting in divided plates, graduated bowls and drinking glasses that incorporate sections marked to show appropriate portions. Other portion-control techniques include assigning a series of points to different food types, and instructing the dieter to eat whatever food they want, provided they do not exceed the number of assigned daily point totals. For some dieters, counting points can be easier than counting calories. Yet other portion-control strategies include pre-package meals that contain the precise daily caloric intake needed for the customer to achieve weight loss. These pre-packaged foods are often expensive, and require the dieter to follow a strict regimen of eating the pre-packaged foods, even though other members of the household may not be on a diet or on a different diet altogether. This can be inconvenient for the meal planner or preparer to create two separate meals—the pre-packaged meal for the dieter and a separate meal for other household members not following the diet. The long-term success of such programs has been poor with well-documented recidivism.

Some estimate that 80 percent of dieters are classified as the “do-it-yourself” dieter. These individuals often do not follow regimented programs for various reasons, such of which are explained above. For instance, programs involving pre-packaged food or weekly weigh-in sessions can be too expensive. Some programs are too complicated by requiring dieters to utilize calorie-counting devices, and compute daily caloric intake. Other programs require the preparation of separate meals for the household. Some programs are difficult to follow when traveling away from home or when eating out at restaurants. Many programs are inconvenient, requiring weekly weigh-ins or counseling at clinics or medical facilities. In addition, programs do not offer a wide variety of foods (they are boring) or do not facilitate the special dietary needs of individual dieters. Some dieters prefer vegan diets, vegetarian diets, or simply do not want to eat the foods of which they are not fond.

Concurrent with the expansive population of dieters, there is a large population of smartphone owners. By some studies, the number of smartphone owners in the United States has topped 115 million, representing about the same percentage of society that is dieting. While there's not a one-to-one matchup between smartphone owners who are also dieting, the growth trend suggests that an increasing number of dieters have, or will have, the capability of taking photos with their smartphone.

### BRIEF SUMMARY OF THE INVENTION

Embodiments of the present invention are generally directed to systems, apparatus, and methods providing dietary and nutritional information, such as portion-size recommendations, portion-selection guidance, and portion-selection feedback. In one embodiment a portion-size recommendation includes a visual representation of the portion size, such as visual indicia overlaying an image of a food item or an image of a reference object. In another embodiment a portion-size recommendation includes an alternative-food recommendation. Another embodiment includes using a user representation (e.g., user image, avatar, and the like) to provide feedback to a user regarding a portion size that has been selected by the user. A further embodiment includes providing feedback to a user as to how a portion size selected by the user compares to portion-size selections of a group of users.

Embodiments of the invention are defined by the claims below, not this summary. A high-level overview of various aspects of the invention is provided here for that reason, to provide an overview of the disclosure, and to introduce a selection of concepts further described in the detailed-description section below. This summary is not intended to identify key or essential features of the claimed subject matter, nor is it intended to be used as an aid in isolation to determine the scope of the claimed subject matter.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 depicts an exemplary general computing environment in accordance with an embodiment of the present invention.

FIG. 2 depicts an exemplary client-server computing environment in accordance with an embodiment of the present invention.

FIG. 3 depicts an exemplary food-calorie table in accordance with an embodiment of the present invention.

FIG. 4 depicts exemplary user-profile input fields in accordance with an embodiment of the present invention.

FIG. 5 depicts exemplary options for dividing daily calories among snacks and meals in accordance with an embodiment of the present invention.

FIG. 6 depicts an exemplary table that shows portion percentages of a food item in accordance with an embodiment of the present invention.

FIG. 7 depicts a flow diagram of steps for performing a method in accordance with an embodiment of the present invention.

FIG. 8 depicts an exemplary portion-suggestion image in accordance with an embodiment of the present invention.

FIG. 9 depicts an exemplary visual indicia in accordance with an embodiment of the present invention.

FIG. 10 depicts an exemplary use of a mobile computing device to send information to, and receive information from, a server in accordance with an embodiment of the present invention.

FIGS. 11 and 12 each depict a respective flow diagram including steps for carrying out a method in accordance with an embodiment of the present invention.

FIGS. 13 and 14 each depict examples of reference items that might be used to visualize a portion recommendation in accordance with an embodiment of the present invention.

FIGS. 15A, 15B, and 15C each depict exemplary screenshots on a mobile computing device in accordance with an embodiment of the present invention.

FIG. 15D depicts exemplary avatar variations in accordance with an embodiment of the present invention.

FIG. 16 depicts a flow diagram of steps for performing a method in accordance with an embodiment of the present invention.

FIG. 17 depicts an exemplary series of steps that are part of a method in accordance with an embodiment of the present invention.

### DETAILED DESCRIPTION OF THE INVENTION

The subject matter of embodiments of the present invention is described with specificity herein to meet statutory requirements. But the description itself is not intended to necessarily limit the scope of claims. Rather, the claimed subject matter might be embodied in other ways to include different elements or combinations of elements similar to the ones described in this document, in conjunction with other present or future technologies. Such embodiments might become known to one skilled in the art (especially after understanding the significant commercial advantages of an unrestricted, very low cost, visual portion control diet program and method, as described herein), and the claimed subject matter includes these other embodiments. Terms should not be interpreted as implying any particular order among or between various elements herein disclosed unless and except when the order of individual steps is explicitly stated. The present invention is not intended to be limited to the disclosed embodiments.

The word “exemplary” is used herein to mean “serving as an example, instance, or illustration.” Any embodiment described herein as “exemplary” is not necessarily to be construed as preferred or advantageous over other embodiments. Likewise, the term “embodiments” is not exhaustive and does not require that all embodiments include the discussed feature, advantage or mode of operation.

### Overview of Some of the Various Embodiments of the Present Invention

Embodiments of the present invention are generally directed to systems, apparatus, and methods providing dietary and nutritional information, such as portion-size recommendations, guidance, and feedback. In one embodiment a portion-size recommendation includes a visual representation of the portion size, such as visual indicia overlaying an image of a food item or an image of a reference object. In another embodiment a portion-size recommendation includes an alternative-food recommendation. Another embodiment includes using a user representation (e.g., user image, avatar, and the like) to provide feedback to a user regarding a portion size that has been selected by the user. A further embodiment includes providing feedback to a user as to how a portion size selected by the user compares to portion-size selections of a group of users.

One exemplary embodiment of the present invention is a system that calculates the appropriate daily caloric consumption of a dieter, and converts the calorie count of each food item in a meal or a snack into a visual representation that identifies the portion of the food item that should be consumed to meet the dieter's weight loss objectives.

Another exemplary embodiment of the present invention is a system that calculates the appropriate daily caloric consumption of the dieter and converts the calorie count into a visual indicia overlaying a photograph of the food item about to be eaten, thereby identifying the portion of the food item that should be consumed.

Another exemplary embodiment of the present invention is a system and method that computes the visual illustration of the portion of food that a dieter should eat, such illustration reflecting the portion of food to be eaten based on the dieter's present weight, and the dieter's target weight.

Yet another exemplary embodiment of the present invention is a system and method allowing a consumer using a hand held and portable electronic device that allows the dieter to photograph their meal, and cause the photographed image to be processed such that a visual indicia of the proper portion of the photographed food is projected over the photograph.

Another exemplary embodiment of the present invention is a software algorithm that considers one or more factors in determining the appropriate portion of food to be consumed, such factors including, but are not limited to, calories contained in the unprepared food, calories added to the food through various cooking means such as grilling or deep frying, the ratio of each food group to the other food groups included in a four food group balanced meal, the dieter's current weight and target weight, relative food satiety levels, and other.

Another exemplary embodiment of the present invention is a system that incorporates one or more of: (a) a client server network comprised of one or more servers; (b) one or more consumer hand held portal devices such as a smartphone or tablet; (c) one or more relational databases containing calorie, dieter profile, food preparation, weight tier, or satiety tables; (d) one or more algorithms; (e) a network comprised of wireless or internet communication means; and (f) one or more applications hosted on cloud-based or hosted servers.

At least one exemplary embodiment of the present invention is to create a diet program that provides an apparatus that allows the dieter to see the appropriate portion of each food group contained on their meal plate in real time via a photograph taken with a smartphone, thereby visually eliminating the portion of the food they should not be eating prior to beginning their meal.

Another exemplary embodiment of the present invention is to create a system that calculates the appropriate daily caloric consumption of the dieter, and convert the calorie count into a visual representation means to identify the portion of their meal or snack that should be consumed.

Yet another exemplary embodiment of the present invention is to create a system that computes the visual illustration of the portion of food that a dieter should eat, such illustration reflecting the portion of food to be eaten based on, but not limited to, such factors as the dieter's present and target weights.

Yet another exemplary embodiment of the present invention is to create a software application to be installed on consumer hand held and portable electronic devices that allows the dieter to photograph their meal, and cause the photographed image to be processed such that a visual indicia of the proper portion of the photographed food is projected over the photograph, thereby instructing the dieter on the precise amount of each type of food on their plate that should be consumed.

Yet another exemplary embodiment of the present invention is to create a method whereby the dieter may interact with the visual indicia projected over the photograph on their hand held device such that the dieter can select the area of food they prefer to eat without changing the total area or volume of food represented by the indicia.

Yet another exemplary embodiment of the present invention is to create a software application to be installed on consumer hand held and portable electronic devices that would allow the indicia to be viewed in two dimensions or three dimensions. Indicia in two dimensions would represent the area of a food item that should be consumed, while the indicia in three dimensions would represent the volume of food that should be consumed by the dieter.

Yet another exemplary embodiment of the present invention is to create a software algorithm that considers one or more factors in determining the appropriate portion of food to be consumed, such factors including, but are not limited to, calories contained in the unprepared food, calories added to the food through various cooking means such as grilling or deep frying, the ratio of each food group to the other food groups included in a four food group balanced meal, the dieter's current weight and target weight, relative food satiety levels,

Yet another exemplary embodiment of the present invention is to create a system that incorporates one or more of: a client server network comprised of one or more servers; one or more consumer hand held portal devices such as a smart phone or tablet; one or more relational databases containing calorie, dieter profile, food preparation, weight tier, or satiety tables; one or more algorithms; a network comprised of wireless or Internet communication means; and one or more applications hosted on cloud based or hosted servers.

One exemplary embodiment of the present invention is a system that can illustrate proper food portions for consumption for individuals who are trying to gain weight. The novel system applied to weight gainers is an important innovation to help growing but obese children, as well as individuals struggling with dangerous under-eating disorders such as anorexia.

One exemplary embodiment of the present invention is system and method that processes an image of food, retrieves from a database the satiety level of the food, and identifies and recommends foods that can be substituted for foods in the photograph, the substituted foods being of a higher satiety level than the food being considered.

Yet another exemplary embodiment of the present invention is to create a system that suggests foods that can be substituted for foods the dieter is considering eating, the substituted foods being of a higher satiety level than the food they are considering. Higher satiety level foods cause the dieter to feel full more quickly and feel satisfied for longer periods of time, thereby reducing hunger anxiety and binge eating.

One exemplary embodiment of the present invention is a system and method that computes the required ingredients for any recipe based on the number of diners who will be sharing the meal. Also included is a component to convert ingredient measurements to the most traditional measurement units (e.g., 11 fluid ounces of an ingredient in the recipe for one person would be 33 ounces for a recipe for three people, approximately converted and displayed as “1 quart”).

Another exemplary embodiment of the present invention is an algorithm that retrieves from a database the nutritional value of various foods in various food groups comprising a recipe for a complete and balanced meal, determining the respective contributions of nutritional components of each food type to the overall meal, retrieves personal dietary profile information of the dieter, and computes and visually displays the correct portion of each food in each food group that should be consumed by a dieter during the meal session.

One exemplary embodiment of the present invention is a system and method that incorporates a client server network comprised of a smartphone and server, the smartphone having an image recognition capability, and upon taking a photograph of a food product retrieves nutritional information from a server and displays indicia of the relative nutritional value of the food product.

Another exemplary embodiment of the present invention is a system and method of a smartphone user to input information into a software application, inputting means including any combination of a smartphone photograph, barcode scan, or manual input of food product information to a database, looking up the first food product in a database, and displaying on a smartphone or other device the nutritional value of the first food product, and comparing the food value of the first product to similar food products that have higher, same or lower nutritional value.

One exemplary embodiment of the present invention system and method of creating a shopping list for a specified number of diners who will be sharing a meal, organizing the different foods and quantities of each food by type that are generally organized in specific areas of a grocery store.

Yet another exemplary embodiment of the present invention is a system and method in which dieters enter into a database, by either barcode scan, manual entry, or taking a picture of food about to be purchased, comparing the food to similar foods in the database, the database thereby including data about each food such as retail price, and presenting a list of alternate foods to the dieter thereby allowing dieters to select the least expensive, most readily accessible food commonly available from local grocery stores or farmer's markets, rather than being required to eat pre-packaged diet foods or maintain a strict regimen of following pre-programmed meal recipes.

Another exemplary embodiment of the present invention is a system and method that consolidates a plurality of menus into a single shopping list, with the food types organized in groups as are generally displayed in various areas of a grocery store.

Yet another exemplary embodiment of the present invention system is a system and method of looking up a first food product using a smartphone by any of the disclosed means, comparing the first food product to similar food products contained in a database and suggesting the purchase of food products similar to the first food product for which discount coupons are offered by the manufacturer or retailer.

One exemplary embodiment of the present invention is a system and method by which a food buyer may select more or similar foods for which coupons are instantly available, and making the coupon code, QR code or other indicia for the discountable food product visible on the display screen of the smartphone and readable by a typical checkout bar code scanner, thereby eliminating the need for a paper coupon.

Another exemplary embodiment of the present invention is a system and method that consolidates two or more coupons into a single indicia such as a barcode, QR code or other electronically readable indicia from which a plurality of coupon discounts for food items purchased are communicated to the checkout computer in a single communication, thereby speeding the crediting of multiple coupons from a single customer, and eliminating the individual paper coupon scanning and storage for retailer redemption.

One exemplary embodiment of the present invention is a system and method of using a smartphone in communication with a database by various communication means to look up a food product, compares the nutritional information of the food product to the user's personal dietary profile and alerting the user of the risks associated with the food product (for example, warning a salt-restricted dieter that salt content in the food product exceeds dietary limits or warning a peanut allergic dieter that the food product contains peanuts). The examples are not exhaustive.

Another exemplary embodiment of the present invention is a system and method of using a smartphone to recommend food products that conform to smartphone users' dietary restrictions or objectives by comparing the nutritional value of various foods contained in a database to the users' personal dietary profile previously inputted and contained in a separate database.

One exemplary embodiment of the present invention is a system and method providing visual feedback in the form of an avatar representing a human dieter wherein a neutral-looking avatar based on the food portion generated by the system represents that the dieter is on track to a weight goal, and in which the dieter can increase or decrease the portion to visualize a smaller body (avatar) as a motivator for faster weight loss, and visualize a larger body (large avatar) as a de-motivator for increasing portions.

Another exemplary embodiment of the present invention is a system and method providing visual feedback in the form of a photograph of dieter wherein the image, computer modified to show a thinner version of the dieter, based on the food portion generated by the system represents that the dieter is on track to a weight goal, and in which the dieter can increase or decrease the portion to visualize a smaller body via a computer enhanced version of the photograph representing a skinnier body as a motivator for faster weight loss, and visualize a larger body via a computer enhanced version of the photograph representing a larger body as a de-motivator for increasing portions.

One exemplary embodiment of the present invention is a system and network wherein dieting members of the social network elect their food portion sizes, such as using the recommended, smaller or larger portions, with the selections recorded in a database, and a mathematical representation of the mean or average of the members or a sub-group of the members is shown on each dieter's account as a motivator to lose weight at the same rate, or faster rate than other members.

### Description of General Computing Environment

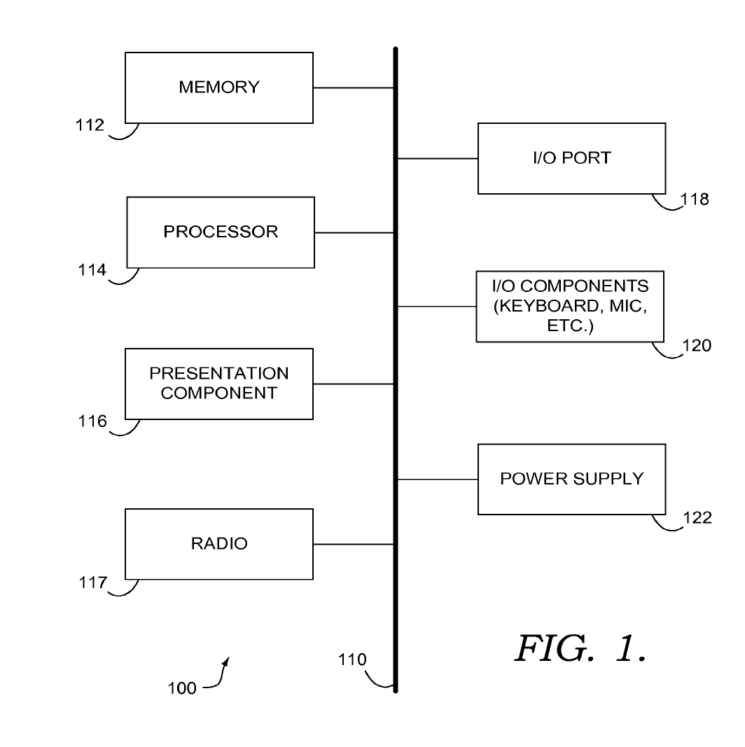

Aspects of the present invention might be embodied in various forms, such as a computing device, a component of a computing device, a method, a computer-storage media, or device that stores instructions, and the like. Referring now to FIG. 1, an exemplary computing environment for implementing embodiments of the present invention is shown and designated generally as computing device 100. Computing device 100 is but one example of a suitable computing environment and is not intended to suggest any limitation as to the scope of use or functionality of invention embodiments. Neither should the computing environment 100 be interpreted as having any dependency or requirement relating to any one or combination of components illustrated.

Embodiments of the invention might be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, radio 117, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media.

Computer storage media includes volatile and nonvolatile, removable and non-removable, tangible and non-transient media, implemented in any method or technology for storage of information such as computer-readable instructions, data structures, program modules or other data. Computer storage media includes RAM; ROM; EEPROM; flash memory or other memory technology; CD-ROM; digital versatile disks (DVD) or other optical disk storage; magnetic cassettes, magnetic tape, magnetic disk storage or other magnetic storage devices; or other mediums or computer storage devices which can be used to store the desired information and which can be accessed by computing device 100.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media, such as a wired network or direct-wired connection, and wireless media, such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors 114 that read data from various entities such as memory 112 or I/O components 120. Presentation component(s) 116 present data indications to a user or other device. Exemplary presentation components include a display device, speaker, printing component, vibrating component, etc.

Radio 117 functions to send and receive signals from a network, such as a telecommunications network. I/O ports 118 allow computing device 100 to be logically coupled to other devices including I/O components 120, some of which may be built in. Illustrative components include a microphone, joystick, game pad, satellite dish, scanner, printer, wireless device, etc.

### Description of Client/Server Computing Environment

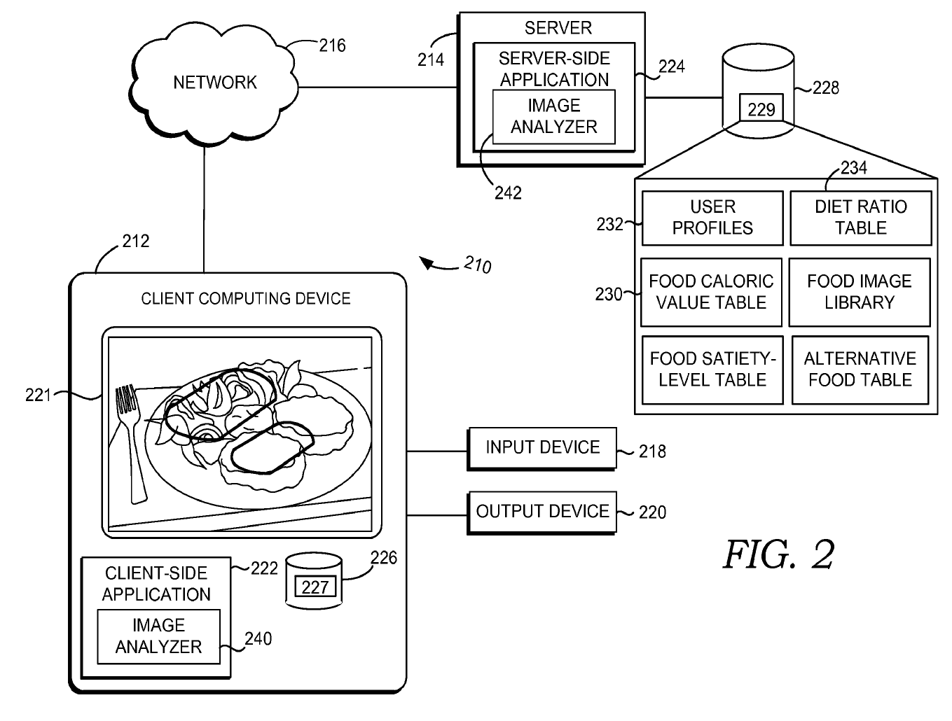

Referring now to FIG. 2, an exemplary environment 210 is depicted in accordance an embodiment of the present invention. FIG. 2 includes a computing device 212 and a server 214 that communicate with one another via a network 216. Both the computing device 212 and the server 214 are types of computing devices that include some or all of the components described with respect to FIG. 1. The network 216 might include various types of networks, such as an intranet, LAN, WAN, mobile-telecommunications network, the Internet, and a combination thereof.

Each of the components depicted by FIG. 2 will now be described in more detail. The computing device 212 might be any of a variety of different device types, such as a mobile computing device (e.g., smart phone), desktop, laptop, tablet, and the like. The computing device 212 includes various components, such as an input device 218, output device 220, and client-side application 222.

The computing device 212 includes other components that are not shown, such as those described with respect to FIG. 1 including a processor and memory. The input device 218 might include various types of input devices, such as a camera, keyboard, touchscreen, microphone, biometrics sensor, gestures receiver, mouse, and the like. The output device 220 might also include various types of output device, such as a display screen 221, speaker, indicator light, or tactile-feedback mechanism.

The client device 212 and the server 214 each include a respective application 222 and 224. In an embodiment of the present invention, the applications 222 and 224 execute operations to provide dietary information, such as portion-size recommendations and portion-size guidance. The applications 222 and 224 might include a distributed configuration in which each application performs respective operations that are combined to complete a process or method. In another embodiment, each application 222 and 224 might perform the same or similar functions and selection of one of the applications to complete a task is based on computing efficiency.

In addition, the client device 212 and the server 214 each include a respective memory device 226 and 228, which stores various information 227 and 229. For illustrative purposes, data 229 is shown in an expanded view to illustrate that data 227 and 229 might include one or more of user profiles 232, a food-caloric-value table 230, a food-satiety-level table, a food-images library, an alternative-food table, and a diet ratio table 234. Although only data 229 is shown in an expanded view, it is understood that some or all of the same information might be stored as data 227. Each application 222 and 224 references the memory devices 226 and 228 when providing dietary information.

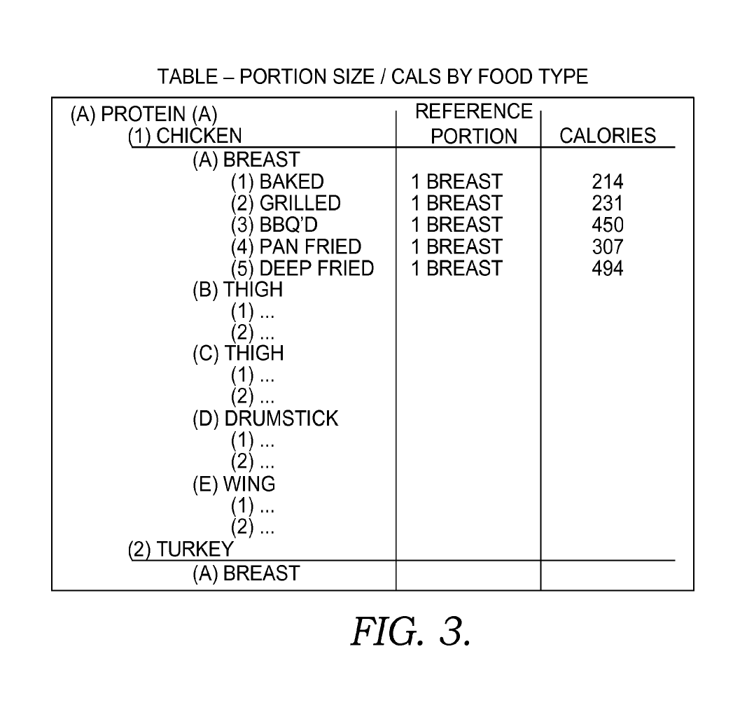

Referring briefly to FIG. 3, an exemplary illustration of the type of information stored in the food-caloric-value table 230 is provided. FIG. 3 depicts a table of information that is organized into categories and sub-categories. For instance, a main category is labeled “(A) Protein” and similar main categories might include “Fat” and “Carbohydrate.” These are merely examples of categories and any suitable organization scheme might be employed in the present invention. The main category “(A) Protein” is broken down into “(1) Chicken” and “(2) Turkey,” and each of these is further broken down into cuts or type and cooking methods. For each cooking method of each type of protein, a caloric value is provided for a reference portion.

FIG. 3 is just one exemplary diagram showing one variation of a food calorie database that computes total food calories of each food type based on how the food was prepared. In order for the portion indicia to be computed accurately for each food that will be consumed, it is helpful for the total calories for each food item to reflect the method of preparation. In one embodiment, a database contained on the server stores one or more food types, along with information that defines a standardized portion, such as the caloric value of a reference portion of a chicken breast. Thereafter, the caloric value of the reference portion can be modified (e.g., increased or decreased) based on the method of cooking or preparation.

In an embodiment of the present invention, an algorithm that computes a recommended portion size takes into account the method of cooking or preparation. For example, as the caloric value of a food item increases as a result of the food preparation method, the recommended portion size is correspondingly reduced in order to maintain the daily caloric intake targets.

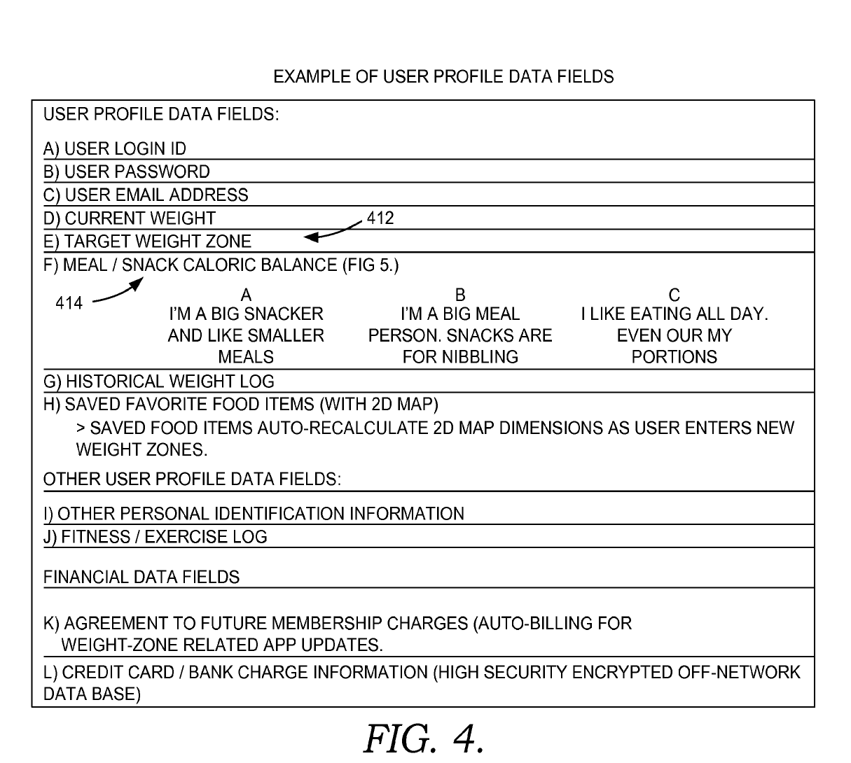

In an embodiment of the present invention, a user establishes an account to utilize the dietary-information application (e.g., 222 and/or 224) by way of a client device 212 (or some other client device). When setting up a user account, user-profile information 232 is generated and is stored, such as in one or both of the memory devices 226 and 228. The user profile 232 might be updated over time. An example of user-profile information is depicted by FIG. 4.

FIG. 4 includes various user-profile data fields that might be completed when a user is setting up his or her account. As such, the user might be led through a series of questions, and the answers are stored in the user profile. Some of the questions might be fill-in-the blank, while others might be multiple choice. In an embodiment of the present invention, the user-profile information is used by the dietary-information application (e.g., 222 and 224) to generate dietary information.

In FIG. 4, one of the information fields includes “Target Weight Zone” 412 and another information field includes “Meal/Snack Caloric Balance” 414. The Target Weight Zone 412 includes a weight range that is a goal of the user. The Meal/Snack Caloric Balance 414 provides a template for how a user would like to distribute calories throughout a typical day.

The information listed in FIG. 4 is illustrative, and a variety of other information might also be specified by a user. For example, a user might specify a preferred diet composition, such as “paleo,” “Zone,” “South Beach,” “DASH,” “ketogenic,” and the like. Each of these diets might include different food-group ratios (e.g., ratio of protein to carbohydrate), and a respective food ratio can then be stored in association with a user (e.g., in the user profile). For reference, the diet ratio table 234 might include predetermined ratios that are associated with a diet. For example, the diet ratio table might specify that if a user specifies the Zone diet, then the food-group ratios should include 40% carbohydrate:30% protein:30% fat.

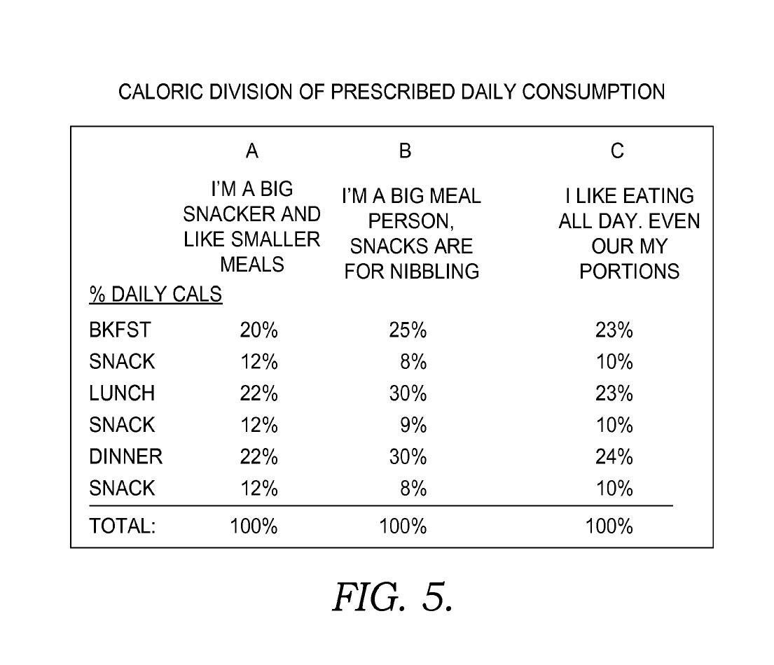

Referring to FIG. 5, an exemplary template is provided that shows how percentages of total daily allotted calories might be distributed based on a Meal/Snack Caloric Balance specified by a user. FIG. 5 is an exemplary diagram showing one variation of creating a customized dieter profile based on the user's eating habits or desired meal frequency and how much food the user prefers to eat at each eating interval. It has been shown that diets that more closely follow the dieter's daily eating routine often result in more successful long-term weight loss than diets that are organized around a standardized eating schedule, which is different from the dieter's normal routine. The user preference set up allows a user to select a daily eating plan from a number of options. Regardless of the option selected, the total amount of calories suggested to be consumed during the day (i.e., in order to achieve target zones or other goals) are then divided over one or more eating periods. Although certain percentages are shown for each meal and snack in the table illustration, there is virtually no limit to the percentages of number of eating timed during a given day, provided that at the end of the day, the dieter has consumed the prescribed number of calories and the proper portions of the major food groups that comprise those calories.

Both the Target Weight Zone 412 and the Meal/Snack Caloric Balance 414 might be used to generate user-specific dietary information, such as portion-size recommendations. For instance, the Meal/Snack Caloric Balance 414 (e.g., FIG. 5) can be used to determine what total amount of calories is recommended to be consumed at a given meal or snack.

In an embodiment of the present invention, a combination of information stored in data 227 and/or 229 might be used to determine a recommended portion size or to determine what percentage of a meal or snack a single food group (e.g., protein, fat, carbohydrate, fruit, vegetable, fiber, etc.) should comprise. For example, once it has been determined that a user is requesting information about a chicken breast to be consumed at a given snack or meal and that the user has specified a particular weight zone, a table can be referenced to lookup the recommended percentage (e.g., 75%). The percentage might represent a percentage or portion of the chicken breast. Alternatively, the percentage might represent a percentage or portion of the allotted calories for that specified snack or meal. In order for the relative portion of each food group to be determined, a ratio of all of the food groups for a particular meal or snack is also stored in data 227 and 229. For instance, as indicated in other portions of this description, a certain ratio might be stored based on a user selection of the DASH diet. This is just one example of how data 227 or 229 might be used, and various other algorithms that account for different factors might be employed.

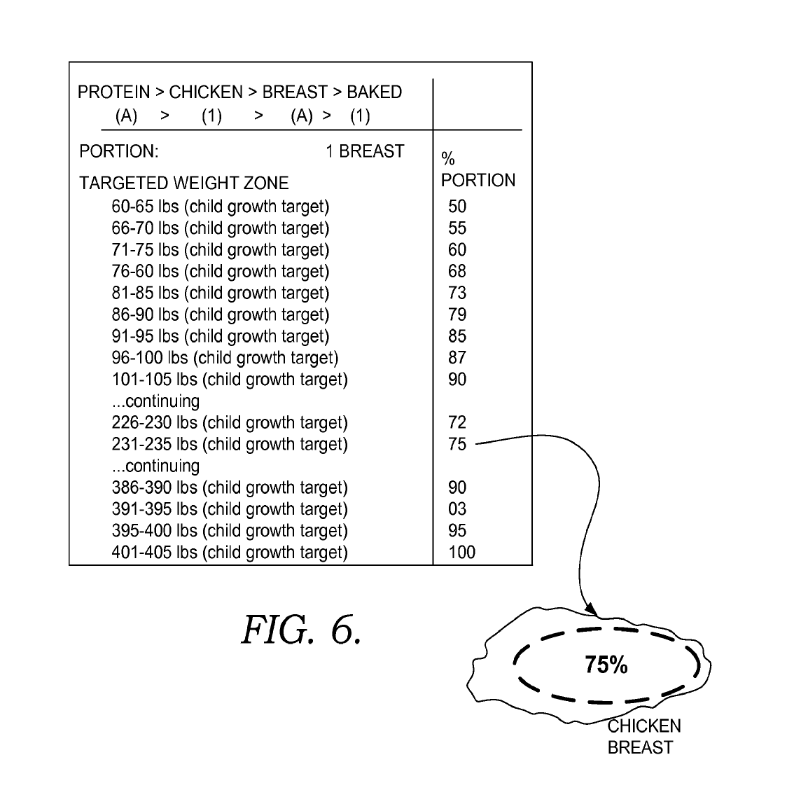

Referring briefly to FIG. 6, an exemplary diagram is depicted showing one variation of a database table and how a lookup might be performed based on a known food item and targeted weight zone. For example, a portion percentage is listed for each target weight zone, such that by referencing a particular weight zone (e.g., 231-235 pounds) a respective portion percentage can be determined.

Various principles and factors can be applied when setting up a database table. For example, portion percentages can be based on a number of age, gender, and weight parameters. It should be noted that one or more parameters may be relied upon to compute the appropriate food portion, and weight factors alone are not intended to be limiting. Other principles and assumptions can also be applied to create a database table (or to apply an algorithm) depending on the current weight, and the target weight of the dieter, the portion of food, which correlates to caloric intake, is shown. For instance, a dieter who weighs 380 pounds will require more calories than a 150 pound person in order to maintain a healthy metabolism. However, the portion of any given food is nevertheless reduced such that the dieter experiences a negative daily caloric intake. Weight loss results when a calorie deficit occurs over time. As the dieter's weight drops over time, there is a corresponding change in the portion of any given food such that a calorie deficit is maintained throughout the weight loss period.

On the other hand, a child requires an increasing number of calories during their formative years in order to support bone and muscle growth. However, in cases where the child is obese, and body mass index reflects too high a fat to muscle mass ratio, portions of each food are determined such that higher caloric density foods are proportionally increased over foods that are considered fat generating. For instance, carbohydrates and sugars will be reduced while vegetables and proteins are increased. Based on the current weight of the dieter, and the standardized weight for the child's gender, height and body type, the percent of a standardized portion of any given food is computed to meet the growing caloric needs, but ratios of the food groups are adjusted to create a reduction in body fat, and an increase in higher density lean muscle tissue. In other words, the ratios are computed such that the child's BMI is reduced over time without putting the child into a risky level of calorie deficit.

The information provided in FIGS. 3-6 is exemplary and various other types of information might be factored in when providing dietary information, such as portion size and food alternatives.

In the embodiment depicted by FIG. 2, both the client-side application 212 and the server-side application 214 are depicted to include a respective image analyzer 240 and 242. However, in other embodiments of the present invention, there might only be one of the client-side image analyzer 240 or the server-side image analyzer 242.

The image analyzer 240 or 242 functions to receive and process images provided by the client computing device 212. For instance, in one embodiment, the image analyzer 240 or 242 performs image recognition to identify a food item depicted by an image. In another embodiment, the image analyzer 240 or 242 performs a color-recognition operation to determine what colors are in the image.

In a further embodiment, the image analyzer performs a calibration to determine a size of the food item. The size might be an approximate real-life size or might be a size that is relative to a reference object. Various techniques might be applied to determine a size of the food item. For example, the calibration tool might assume that the image was captured a default distance away from the camera (e.g., 12 inches). In addition, an object with a known approximate size (e.g., eating utensil, dollar bill, a coin, etc.) might be included in the picture as a size reference. As an example of a calibration tool typically available at meal-time, a fork may be used to communicate to the image processing software application the approximate physical size of the food item. When the food item is photographed along with the fork, the image processing software application will more accurately represent to the portion indicia computing means an approximately more accurate size of the food portion, and correspondingly compute the appropriate portion indicia.

In a further embodiment, the image analyzer 240 or 242 optimizes an image, such as by enhancing or changing a color of the food item to improve visibility, rotating the image, or increasing the size of the representation of the food item. Image processing software is disclosed that would optimize the photographic image, for instance by realigning the intended food group to substantially fill the user's viewing screen on the hand held electronic device.

In an embodiment of the present invention, the elements and components described with respect to FIG. 2 are leveraged to provide dietary information to a client computing device 212, such as portion-size recommendations, portion-selection ratings, alternative-food suggestions, and the like.

### Providing Dietary Information and Recommendations

Various functions and operations of a dietary-information application, such as the applications 222 and 224, will now be described in accordance with an embodiment of the present invention. When describing a dietary-information application, reference is made to FIG. 2, as well as some of the other figures. Specific reference might not be made to either of the applications 222 and 224 when describing a particular operation, but it is understood that either application might carry out these described functions. In an embodiment of the present invention, the dietary information application provides nutritional information about a food item, portion-size recommendations, and assessments of portion selections.

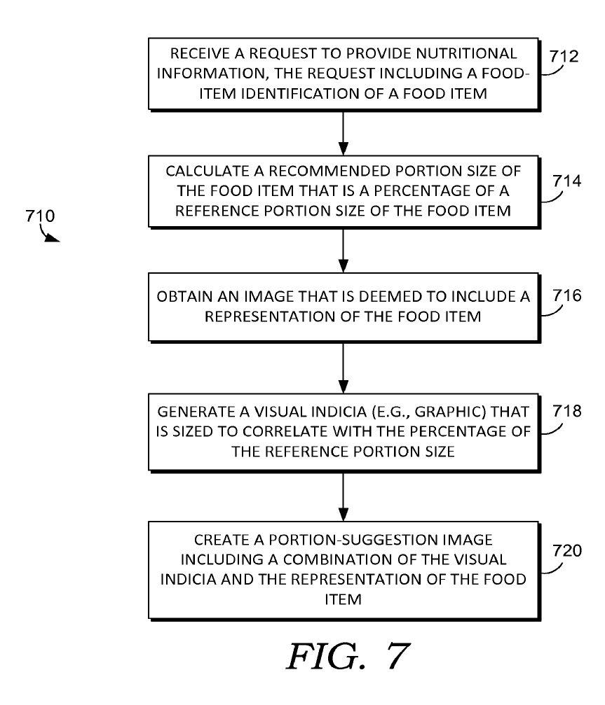

Referring now to FIG. 7, a flow diagram is depicted of a series of steps or operations that are carried out in accordance with an embodiment of the present invention in order to perform a method 710. The method 710 is directed to providing a visual indicia of portion size. The invention might be embodied as a computer-implemented method that includes the steps summarized in FIG. 7. The invention might also be embodied as a computing device that is programmed to perform the operations outlined in FIG. 7. In another embodiment, the present invention includes a computer-storage device storing computer-executable instructions that, when performed by a computing device, perform the method 710. When describing method 710, reference is also made to other figures for illustrative purposes.

At step 712, the method 710 includes receiving a request to provide nutritional information, the request including a food-item identification that includes a name of a food item. For example, a user might open the client-side application 222 on his or her client computing device 212 (e.g., smartphone) and type the food the user intends to eat from one of the food groups (e.g., protein, carbohydrate, fat, dairy, vegetable, fruit, and the like). The user might independently determine that he or she wants to consume the food item and independently open the client-side application 222. In an alternative embodiment, daily meals and snacks might be organized on a 12-hour or 24-hour schedule that is based on a diet specified by the user in the user profile. As such, the client-side application 222 might alert the user that it is a suggested time for a meal or snack.

In one embodiment, the input provided by the user might include various details, such as the food name (e.g., chicken, pork, beef, fish, etc.) and the method of cooking or preparation. The input might include user-textual input that is provided by the user. Or in another embodiment, the user might select an image of the food item from a collection of food-item images provided by the server 214 or client device 212. For instance, if the user inputs the food group “protein,” then the application 222 or 224 might provide a set of images to choose from, including chicken, pork, and beef Alternatively, the user might provide an image of the food item that is recorded by the client computing device 212, in lieu of selecting the stock image. The client computing device 212 submits the request for information about the food item, which is received by the client-side application 222 or the server-side application 224.

The method 710 further comprises, at step 714, calculating a recommended portion size of the food item that is a percentage of a reference portion size of the food item. Step 714 might be performed by either the client-side application 222 or the server-side application 224, and includes retrieving various pieces of information and applying an algorithm to calculate the recommended portion size. For example, the application 222 or 224 might retrieve various pieces of information from memory device 226 or 228, or the application 222 or 224 might request additional information from the user by way of the client computing device 212. Retrieved information might include a caloric value of a reference portion size of the food item (e.g., food caloric value table), a total caloric allotment of the meal or snack in which the user intends to eat the food item (e.g., user profile), a diet ratio specified for the user (e.g., diet ratio table), dietary objectives or targets specified for the user (e.g., user profile), or a combination thereof. The application 222 or 224 then applies an algorithm to the retrieved data to determine a recommended portion size.

Step 716 includes obtaining an image that is deemed to include a representation of the food item. For example, the image might be retrieved from the food image library stored in memory device 226 or 228. Alternatively, the image might be recorded by a camera of the client computing device 212, which provides the image to the application 222 or 224. If the image is a user-supplied image, then the image analyzer performs various operations, such as calibration, recognition, optimization, color recognition, image enhancement, or a combination thereof.

At step 718, the method 710 includes generating a visual indicia (e.g., graphic) that is sized to correlate with the percentage of the reference portion size. That is, the graphic represents the recommended portion size calculated in step 714, respective to the reference portion size. The visual indicia might include various types of graphics or representations.

In one embodiment of the present invention, the visual indicia includes a two-dimensional (2D) shape or line (e.g., circle, oval, rectangle, etc.) that includes a shape-defining boundary and that defines an area. In another embodiment, the visual indicia includes a three-dimensional (3D) shape (e.g., wire frame) that includes shape defining boundaries and that defines a volume.

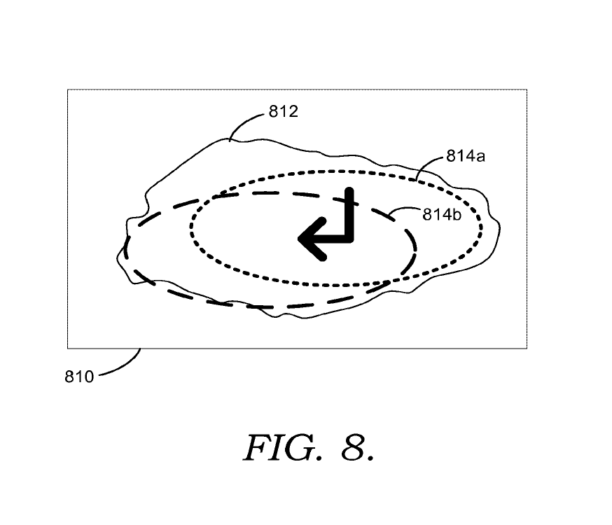

Step 720 includes creating a portion-suggestion image including a combination of the visual indicia and the representation of the food item. Referring briefly to FIG. 8, an exemplary portion-suggestion image 810 is depicted that includes a food-item representation 812 and visual indicia 814a and 814b. When the portion-suggestion image is viewed by the user, the visual indicia 814a provides a visual cue as to what portion of the food item 812 he or she should consume in order to comply with dietary recommendations. The user can then choose to eat only the portion of the food item that is bound by the visual indicia.

The portion-suggestion image 810 and visual indicia might include several features. For instance, in one embodiment, the visual indicia 814a can be dragged or panned from a first position to a second position, which represented by visual indicia 814b. This feature allows a user to select a different part of the food item that is still consistent with the portion recommendation.

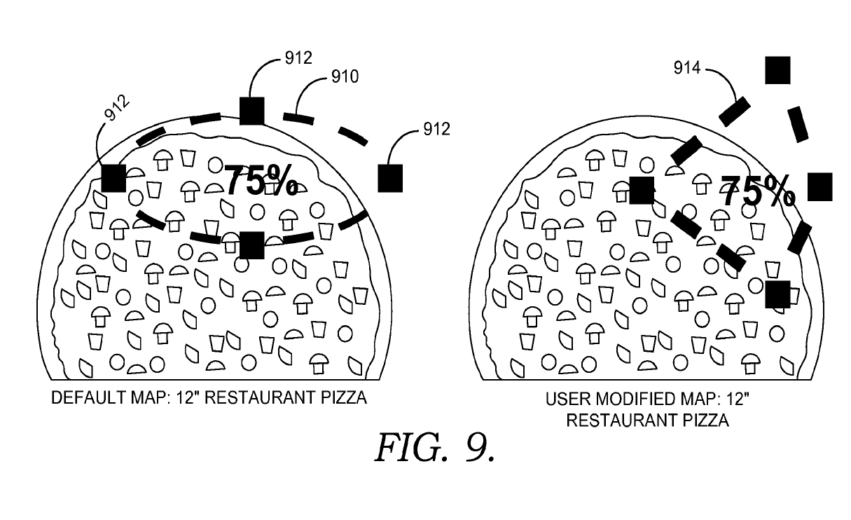

In another embodiment, the visual indicia 814a is configured to include handles, which allow the shape of the visual indicia to be modified without changing the overall area. This feature is helpful when food items are served in shape configurations that do not match the shape of the visual indicia. For example, referring to FIG. 9, pizza portions or servings are often cut into a triangle or rectangle. Thus, in an embodiment of the present invention, an ovular visual indicia 910 could be re-shaped using the handles 912 into another visual indicia 914, which includes a triangle, rectangle, or other desired shape, without changing the area of the visual indicia.

In a further embodiment, the visual indicia is configured to include a color that contrasts with one or more colors of the food-item representation. For example, when the image is processed by the image analyzer, colors of the food-item representation might be identified. In addition, colors might be included as metadata of the image. Accordingly the application 222 or 224 might create the visual indicia to include colors that contrast with the food-item representation to enhance viewability on the client computing device 212.

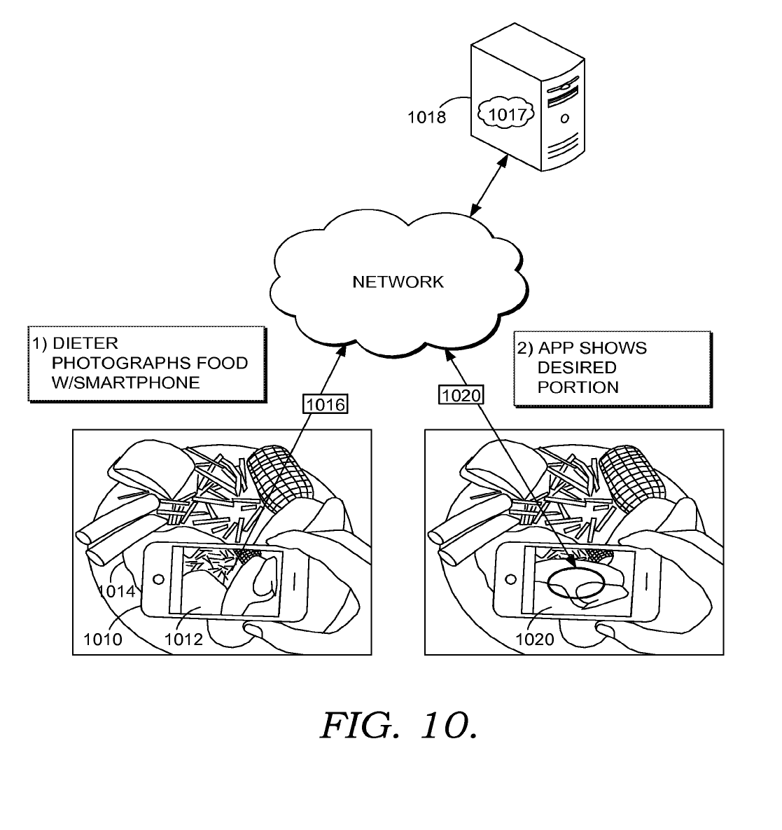

Referring to FIG. 10, a schematic pictorially depicts an embodiment of the present invention that is consistent with the method 710. In FIG. 10, a smartphone 1010 is used to record an image 1012 of a food item 1014. The image of the food item might be processed using image-processing software, and is realigned to more appropriately fill the user's screen. This ensures that the maximum resolution and image size of the food is delivered to the dieter. A request 1016 is then sent from the smartphone 1010 to an application 1017 hosted on a server 1018 (i.e., via the network or cloud). The application 1017 applies an algorithm to compute a recommended portion size, such as by retrieving information from the various databases described in FIG. 2, and creates a visual indicia, which is sent to the client computing device, such as by way of data 1020. The visual indicia is depicted on the smartphone in a portion-suggestion image 1022. The display of the originally photographed food item, along with the portion indicia, serves as a guide from which the dieter can determine approximately how much of the original food item can be consumed during the present meal.

Portions of the food item can be removed and stored as leftovers for another meal in the future. At such time that the user elects to consume some of the leftovers, the user can again use the same process disclosed in the present invention to visualize the proper portion of the leftover item for consumption during a subsequent meal.

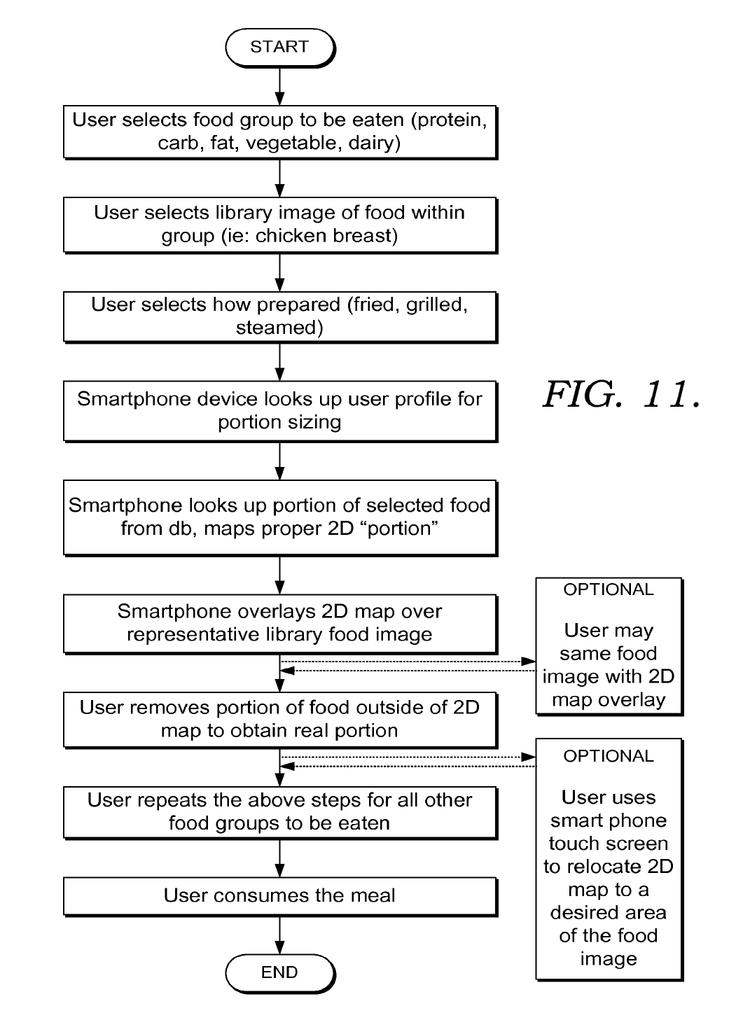

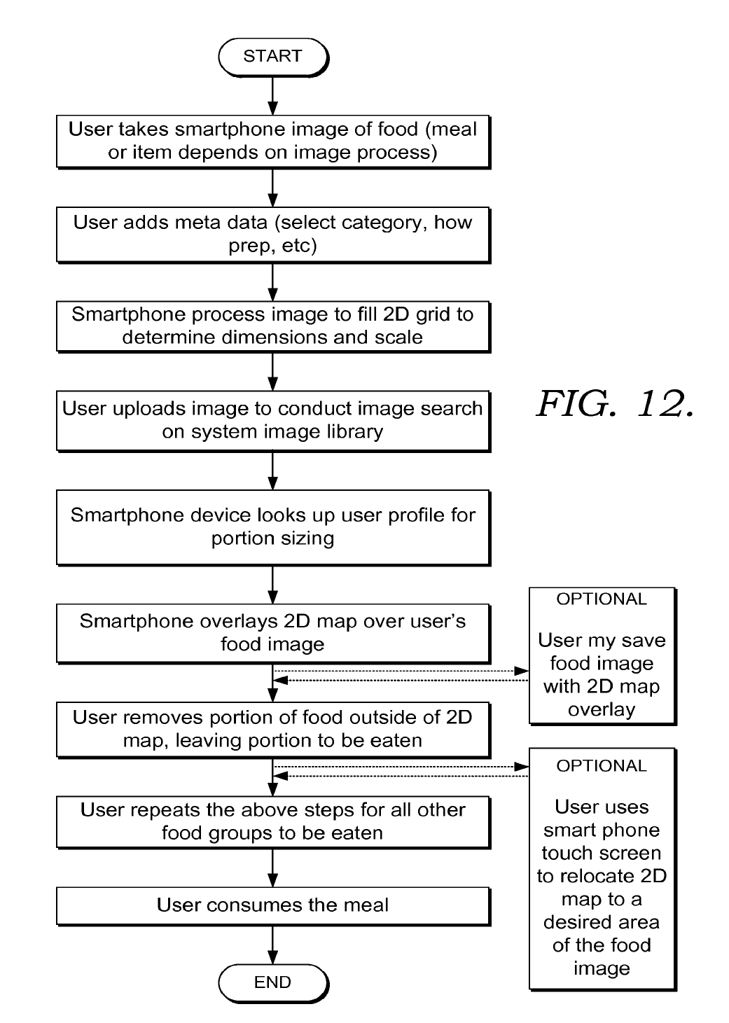

FIG. 11 is an exemplary diagram showing one variation of the method and process of creating indicia defining a portion of the dieter's food that should be consumed. In the diagram, the user opens the software application on the user's hand held electronic device, and selects the type of food they intend to eat from one of food groups comprising protein, carbohydrate, fat, dairy of vegetable. An image of a standardized representation of the selected food is called to the user's hand-held device from the system's database on a server.

The user uses interactive means on the hand-held device to specify the method by which the food is prepared. For example, the food may be fried, grilled, boiled, steamed or baked. Each method of food preparation changes the total calories of the food to be eaten.

Upon receiving the method of food preparation from the user's hand held device, the database calls on the user's profile data, the food calorie database, and food method of preparation database, along with other databases deemed necessary to compute the portion size of the food, and computed the area of the food that defines the proper portion that should be consumed, and generates visual indicia defining the portion of the food image that should be consumed. In addition, certain pieces of meta data might be stored with the image of the food item, such as portion size, portion weight, number of pieces per portion, total calories, and the like, such that these pieces of information can be retrieved from the meta data of the image when the visual indicia is being determined.

At an appropriate time in the process, the client hand held device or the server will look up the user's profile to determine the baseline daily caloric intake for that user at the instant period on the user's weight loss continuum.

Following the overlay of the indicia upon the food image, the dieter then cuts or otherwise divides the subject food to approximate the area of food defined by the indicia on the image of the food. By removing the portion of food that exists beyond the boundaries of the indicia, the user is left with the remaining food that approximates the proper portion that the dieter should consume.

Upon completing the process for one food group, the user repeats the process for each of the other food groups. After completing the portion visualization for each food group, and removing the portion of food residing beyond the indicia boundaries for each food group, the remaining food constitutes a balanced, properly portioned meal.

It should be noted that the user's hand held electronic device may include, but is not limited to a smart phone, tablet computer, laptop computer, or desk top computer, so long as the device contains a viewing screen upon which the food image and indicia can be displayed.

Various means may be employed to accelerate the processing time needed to compute and display the portion indicia, including but not limited to performing computational analysis by using the microprocessor of the user's hand held electronic device, saving the first computation to a cache contained on the server or upon the user's hand held electronic device, or by allocating appropriate microprocessor allocation upon the cloud or server.

FIG. 11 is exemplary diagram showing another variation of the method and process of creating indicia defining a portion of the dieter's food that is recommended to be consumed. In the method depicted by FIG. 11, a photograph of the food is generated by the user on the user's hand held electronic device, as opposed to selection of a library stock image as described in FIG. 10.

Image processing software is disclosed that would calibrate and optimize the photographic image, for instance by realigning the intended food group to substantially fill the user's viewing screen on the hand held electronic device.

The image is subsequently uploaded to the server, and used as a representative image for searching for comparable standardized images contained in an image library. The two dimensional or three dimensional indicia is delivered via a network to be displayed, together with the user's food image, upon the user's hand held electronic device.

In another embodiment, the user's hand held electronic device contains the photographic image of the user's food, and meta data entered into the hand held electronic device by the user to define the food group, method of preparation, and other pertinent information. The data, but not the photographic image of the food is transmitted to the database and server of a network where an algorithm is applied, and the portion indicia area or volume is computed, and only the indicia mapping information is communicated back to the hand held electronic device for presentation over the user's food photograph for display on the hand held device viewing screen.

### Additional Embodiments

An additional embodiment of the present invention is directed to another method of providing dietary recommendations, including receiving a request to provide a dietary recommendation, the request including a food-item identification including a name of the food item. One or more characteristics of the food item are identified and a dietary parameter is determined by referencing a user profile. The method further includes determining that the one or more characteristics fail to satisfy the dietary parameter, and a notification is provided indicating that the food item fails to satisfy the dietary parameter.

In one embodiment, the one or more characteristics of the food item include a caloric value of the food item and the dietary parameter includes a caloric-intake value (e.g., per snack allotment) that is based on a target body weight. In another embodiment the one or more characteristics includes a food group into which the food item is classified, and the dietary parameter includes a dietary regiment having a set of prescribed food groups, the dietary regiment including a respective prescribed daily amount of each food group included the set of prescribed food groups. For example, if a user has specified a relatively high-protein diet, an embodiment determines whether the food item (when combined with other food items in the meal or snack) is consistent with the ratio of protein to carbohydrate to fat that the high-protein diet specifies.

In a further embodiment, the method also includes identifying an alternative food item that is deemed to satisfy the dietary parameter, and the notification recommends the alternative food item. For instance, if the food item includes a caloric value that is too high, then an alternative food item is suggested that has a lower caloric value consistent with the user profile. Or, if the user profile specifies a diet type (e.g., paleo diet), and the food item is not included in the diet type (e.g., processed grains), then an alternative food item (e.g., rib eye steak with broccoli) is suggested that is included in the diet type. In a further embodiment, a recommended portion size of the alternative food item is calculated that is a percentage of a standard portion size. An image is obtained that is deemed to include a representation of the alternative food item, and a graphic is generated that is sized to correlate with the percentage of the standard portion size. A portion-suggestion image including the graphic overlaying the representation of the food item is created, and the notification includes the portion-suggestion image.

Another additional embodiment of providing a dietary recommendation includes receiving a request to provide a dietary recommendation, the request including a food-item identification including a name of the food item. A satiety level of the food item is determined by referencing a satiety table, and an alternative food item is identified that includes a higher satiety level, which exceeds the satiety level of the food item. A dietary-recommendation notification is provided that suggests consumption of the alternative food item as opposed to the food item. In such an embodiment, the invention might further include calculating a recommended portion size of the alternative food item that is a percentage of a standard portion size, and obtaining an image that is deemed to include a representation of the alternative food item. In addition, a graphic is generated that is sized to correlate with the percentage of the standard portion size, and a portion-suggestion image is created that includes the graphic overlaying the representation of the food item, wherein the dietary-recommendation notification includes the portion-suggestion image.

Another additional embodiment of providing a dietary recommendation includes receiving a request to provide a dietary recommendation, the request including a food-item identification including a name of the food item, a food group, or a combination thereof. In addition, a better-food-selection button is provided by way of the graphical user interface on the client computing device. As such, a selection of the best-food-selection button can be received, which indicates a request to provide a food recommendation. The food recommendation might include a variety of other foods, such as a food that is deemed to better satisfy dietary objectives, such as those identified in the user profile. The food recommendation might also include a variety of foods that are deemed good options from a food group (e.g., good sources of complete protein, healthy fats, high-fiber foods, and the like).

In another additional embodiment of the present invention for providing dietary information, a request is received to provide nutritional information, the request including a user-provided image that includes a representation of a food item. The user provided image is analyzed to determine a name of the food item, and the nutritional information is retrieved that describes the food item. The nutritional information that is relevant to the user-provided image is provided to a client device. The request might be generated by the client device, which had recorded an original version of the user-provided image (e.g., using a camera on a smartphone). In a further aspect, retrieving the nutritional information includes sending a request to a server. In addition, the invention might further include determining a total caloric value associated with a standard portion size of the food item, and calculating a recommended portion size that is a percentage of the standard portion size. A graphic is generated that is sized to correlate with the percentage of the standard portion size, and a portion-suggestion image is created that includes the graphic overlaying the representation of the food item in the user-provided image, the portion-suggestion image being provided as part of the nutritional information.

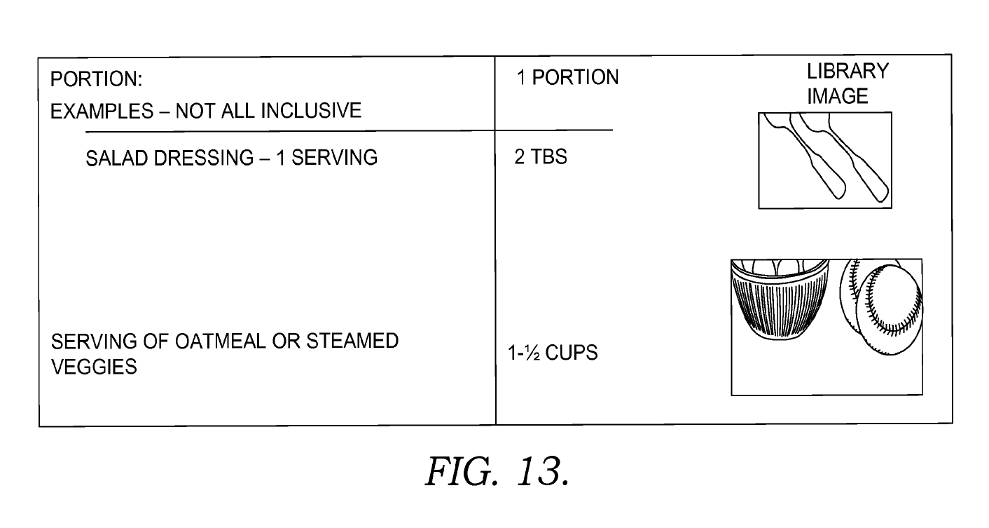

In another additional embodiment of the present invention for providing dietary information, a request is received to provide a portion recommendation of a food item, the request including a name of the food item. Accordingly, an image of a reference item that includes a size is retrieved, which corresponds to a recommended portion size, and the image is provided to be rendered on the client computing device. For example, referring to FIG. 13, an exemplary table is depicted showing how reference images might be stored that show exemplary portion sizes.

FIG. 13 suggests that if 1.5 cups of oatmeal or steamed vegetables are recommended, then an image of a baseball might be provided as a reference item. FIG. 14 shows other reference items that might be provided in images as an example of a portion size, such as a computer mouse, a compact disc, a light bulb, dice, a hockey puck, a poker chip, and a deck of cards. The recommended portion size includes a standard or reference recommended portion (e.g., 4 ounces). Or the recommended portion size might include a user-specific recommended portion size, which is based on dietary objectives of the user. A database containing visual representations of various portions provides dieters with a quick look up of visual portion sizes compared to commonly recognizable items. This reference tool can be valuable when a dieter is preparing a meal, or preparing to eat a food item for which a recommended quantity is known, simply by comparing the size of portion of the food item to a recognizable item. For instance, it's well known that 4 ounces of meat is a proper portion size for an average dinner serving. However, it is difficult to visualize how much meat represents 4 ounces, especially when the meat is delivered as a 16-ounce steak at a restaurant. By referencing the image portion database for 4 ounces of meat, the dieter will learn that the appropriate 4-ounce portion is equivalent to a standard deck of playing cards. This representative illustration can be visualized by the dieter who then cuts meat to a size that approximates the size of a deck of playing cards for consumption.

An embodiment of the invention might also include determining the user-specific recommended portion size by referencing a user profile to retrieve one or more user-specific dietary parameters, the user-specific recommended portion size being based on the one or more user-specific dietary parameters. Retrieving the image of the reference item might include referencing an image-portion database to lookup the image based on the name of the food item and the user-specific recommended portion size.

An additional embodiment of the present invention includes displaying an image including a food-item representation on a display device and displaying a pictorial representation of a user on the display device. For example, pictorial representation might include an avatar or a digital image of the user. A graphic is overlayed on top of the food-item representation, the graphic including a border that defines a graphic size (e.g., FIG. 8). In input is received to change the graphic size, and the pictorial representation of the user is transformed based on the change in the graphic size. In one aspect, the input to change the graphic size includes modifying the border, such as by dragging an edge of the border. For example, the input to modify the border might include a touch input that is received by a touch-sensitive interface. An embodiment of the present invention might further include displaying a slider bar that presents a range of size-modification commands, wherein receiving the input to modify the border includes receiving a selection of a size-modification command of the slider bar. In one embodiment, when the input to change the graphic size includes increasing the graphic size, then transforming the pictorial representation of the user includes increasing a size of the pictorial representation. Alternatively, when the input to change the graphic size includes decreasing the graphic size, then transforming the pictorial representation of the user includes deceasing a size of the pictorial representation. In a further embodiment, transforming the pictorial representation of the user includes changing a color of the pictorial representation.

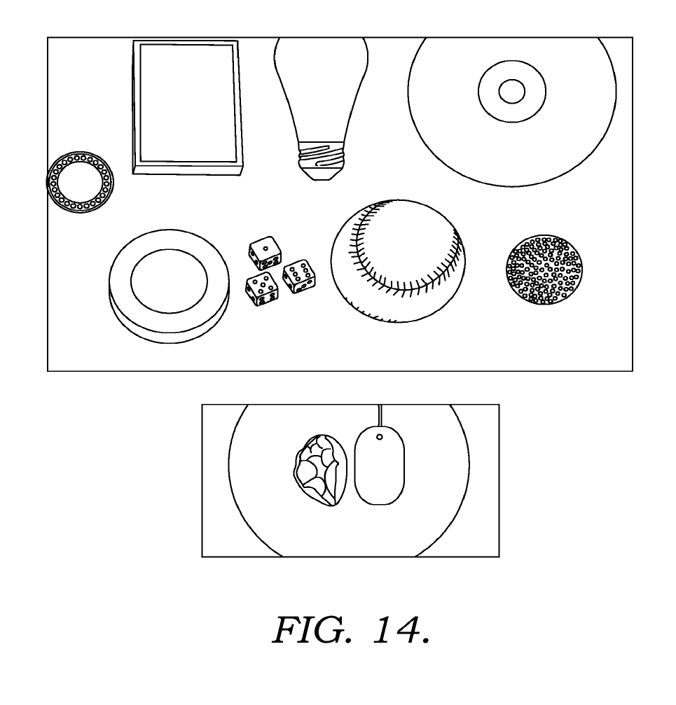

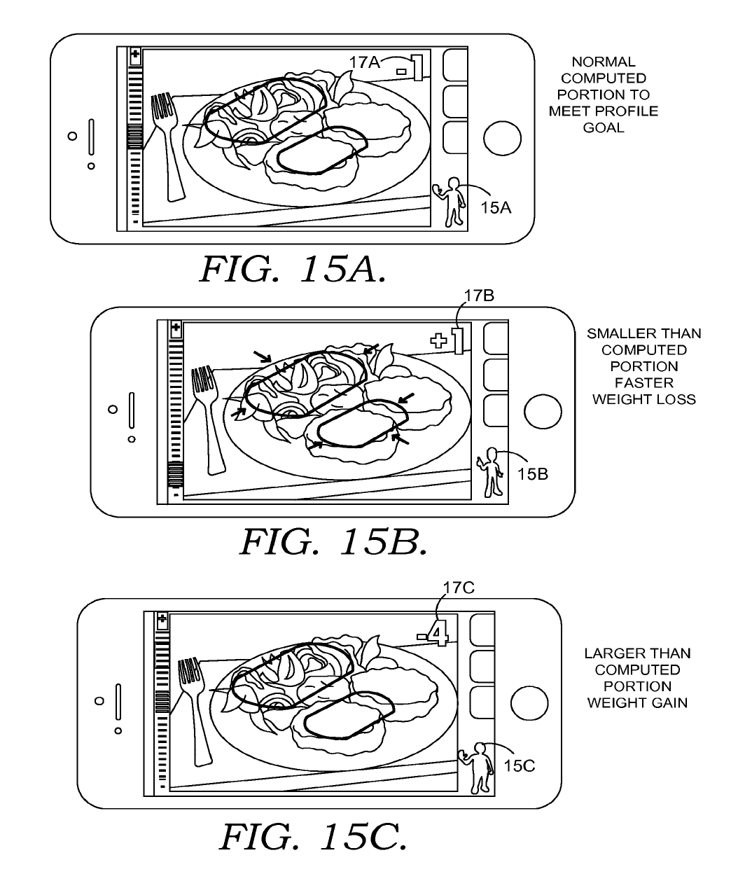

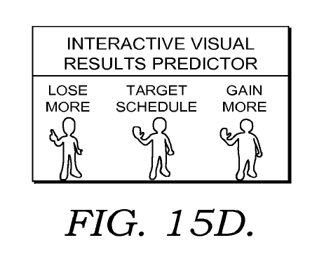

Referring to FIGS. 15A, 15B, and 15C, exemplary screenshots are depicted that help to illustrate some embodiments of the present invention. FIGS. 15A, 15B, and 15C include a series of exemplary diagrams showing computed indicia overlaying a digital image of food about to be consumed. The user interface provides one or more components (e.g., slider bar, pinch and spread touch gestures, and the like) that allow the user to increase or decrease the visual indicia dimensions that correspond to food portions. In response, the application interactively changes the size of the user representation 15A, 15B, and 15C (e.g., avatar or a photo of the user) illustrating their relative body size if they consume less than, or more than the recommended food portion.

In FIG. 15A, the visual indicia computed based on the user's personal profile is shown. Also, on the left side of the screen, a touch-screen slide bar is provided, although other locations and alternatives to slidebars may be used to accomplish the same function. On the right side of the screen, an avatar 15A representing the dieter is shown in a neutral state, but a digital image of the user might also be used. The neutral state is signified by an avatar having a certain size and color and indicates that the suggested portion size is on track with their weight loss or weight management goals.

In FIG. 15B, the user slides the slidebar to reduce the indicia size, and correspondingly reduce the food portion. As the slidebar is being moved, the caloric portions are also computed. The result of eating less might be faster weight loss, such being reflected with the “thinner” avatar 15B, providing a visual inducement and motivation to stay on the diet and lose weight. In another embodiment depicted in FIG. 15C, if the dieter increases the food portions (such as by using the slider bar), the color and size of the avatar interactively changes to represent weight gain and increase in body mass size. For illustrative purposes, FIG. 15D depicts exemplary avatars having sizes that suggest a portion size will result in more or faster weight losses, on-target weight losses, or weight gain.

The dashboard type of components that provide interactive feedback are not meant to be limited to a slidebar and shrinking/growing avatar, but may also include a calorie counter that increments or decrements in response to the slidebar movement, or may provide increase/decrease information regarding any other nutritional component, food price, satiety levels or other data.

Another additional embodiment of the present invention includes receiving a request to provide nutritional information, the request being associated with a user profile and including a food-item identification that includes a name of a food item. A recommended portion size of the food item is determined that is a percentage of a reference portion size of the food item, and an image is obtained that includes a representation of the food item. A graphic or visual indicia is generated that is sized to correlate with the percentage of the standard or reference portion size, the graphic being overlaid over, or superimposed on, the representation of the food item to create a portion-suggestion image. A group score is determined that quantifies portion-size selections of a group of users. For example, portion selections of a group of dieters might be logged and averaged to assess how the group is doing as a whole. This group of dieters might be a group of users that are associated by way of a social network. Once the group score is determined, the recommended portion size is rated, such as by comparing the recommended portion size to the group score to determine whether the recommended portion size is higher than, lower than, or consistent with the group score. The portion-suggestion image is provided to a client computing device together with a portion-selection rating, which indicates whether the recommended portion size is higher than, lower than, or consistent with the group score.

Referring back to FIGS. 15A, 15B, and 15C, portion-selection ratings 17A, 17B, and 17C are depicted that indicate how the recommended portion size (as indicated by the graphic or visual indicia overlay) compares to a group score. Thus, the portion-selection rating allows a user to assess whether his or her portion selection is higher, lower, or consistent with a group score.

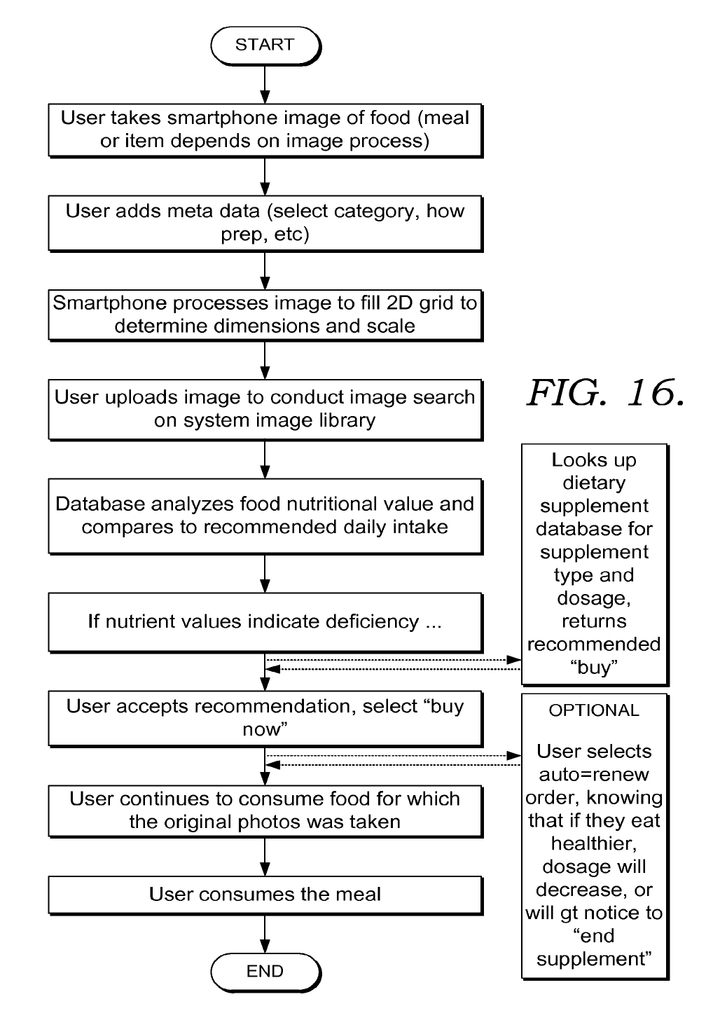

FIG. 16 is an exemplary diagram showing a system and method of computing the nutritional value of food consumed by a person, of computing the difference between recommended daily consumption of food nutrients and the actual amount of essential nutrients consumed, and determining an appropriate dose of the nutritional supplements necessary to normalize the deficiencies, and a system and method to allow instant ordering of the recommended nutritional supplement and dose.

According to the flow diagram, a dieting person takes a photograph of the meal about to be consumed. Using the system and method previously described, the caloric and nutritional value components of the meal are computed. Further, the system and method provides for the dieter's personal profile to be accessed, and the portion of the meal that should be consumed in order for the dieter to meet their weight loss goals is computed and determined. Thereafter, a digital map showing the appropriate portion of the meal that should be eaten by the dieter is overlaid on the photograph.

Still further, as can be readily determined by one skilled in the art, since the nutritional value of the portion of the meal is computed, so too is it possible to compute the difference between the nutrients actually consumed, and the recommended consumption of each nutrient.

In the drawing, once the nutrient deficiencies are determined, a proper dosage of the nutrient in which the dieter is deficient is computed, and by referencing a lookup table of nutritional supplements, the system and method returns to the dieter a purchase recommendation of the nutritional supplement, thereafter allowing the dieter to instantly purchase the supplement.

FIG. 16 represents is a continual process, and over time, the nutritional deficiencies of a dieter may change in response to modifying their diet. In such cases, the recommended purchases of nutritional supplements will also change accordingly, thereby continuing to ensure that the dieter maintains a long-term, healthy intake of essential nutrients.

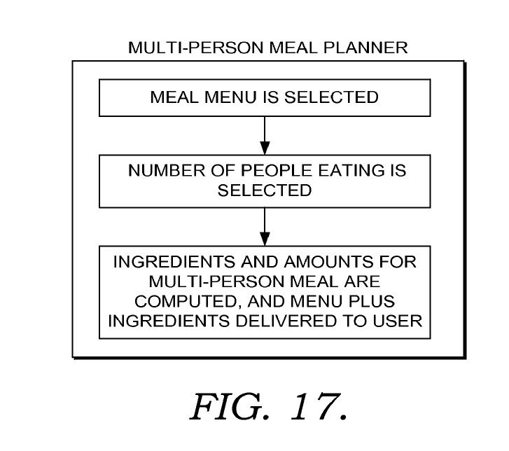

Referring to FIG. 17, an exemplary diagram depicts one variation of a meal planner that computes total meal planning ingredients and portions based on the number of individuals for which the meal will be prepared. This novel feature provides for the dieter to: (a) select a meal recipe from the database; (b) input the number of individuals they will be preparing the meal for; and (c) receive a modified ingredients list that is adjusted for the number of diners the meal is intended to serve.

In most all cases, meal planning or recipe books inherently are written for an arbitrary but fixed number of dieters. For instance, a recipe for macaroni and cheese may indicate that the recipe “serves 6”. If the preparer is only preparing a meal for 2 people, they will have to try to compute a ⅓rds proportion of each ingredient. This is both complicated and cumbersome. If the preparer elects to prepare the entire recipe, counting on storing leftovers after serving only 2 diners, then the preparer has spend ⅔ more on the meal than they otherwise would have if the recipe was designed for two servings to begin with.

This multi-person meal planner removes guess work and complications from computing ingredient amounts for a different number of diners, and might enable the preparer to save money and reduce waste by preparing more food than is required for the present meal.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein. Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method of providing dietary recommendations comprising:
receiving a request to provide nutritional information, the request including a food-item identification that includes a name of a food item;
calculating a recommended portion size of the food item that is a percentage of a reference portion size of the food item;
obtaining an image that is deemed to include a representation of the food item;
generating a graphic that is sized to correlate with the percentage of the reference portion size; and
creating a portion-suggestion image including a combination of the graphic and the representation of the food item.

2. The method of claim 1, wherein the food-item identification includes a method of food preparation and wherein a caloric value associated with the reference portion size is dependent on the method of food preparation.

3. The method of claim 1, wherein calculating a recommended portion size includes referencing a user profile to retrieve one or more user-specific dietary parameters and wherein the recommended portion size is based on the one or more user-specific dietary parameters.

4. The method of claim 1, wherein obtaining the image includes receiving a user-provided image that is supplied by a client computing device.

5. The method of claim 1, wherein obtaining the image includes referencing the food-item identification in a datastore to retrieve a stored image.

6. The method of claim 1, wherein the graphic is a two-dimensional indicia that defines an area and that is overlaid on the representation of the food item.

7. The method of claim 6, wherein the graphic is adjustable to pan the graphic respective to the representation of the food item.

8. The method of claim 6, wherein a boundary line of the two-dimensional indicia is adjustable to modify a shape of the two-dimensional indicia without modifying the area.

9. The method of claim 1, wherein the graphic is a three-dimensional indicia that defines a volume and that is overlaid on the representation of the food item.

10. A computer memory device storing computer-readable instructions that, when executed, perform operations for providing dietary recommendations comprising:
receiving a request to provide a dietary recommendation, the request including a user-supplied image, which includes a representation of a food item, and a food-item identification including a name of the food item;
calculating a recommended portion size that is a percentage of the standard portion size;
generating a graphic that is sized to correlate with the percentage of the standard portion size; and
creating a portion-suggestion image by superimposing the graphic over a portion of the user-supplied image.

11. The computer memory device of claim 10, wherein the operations further comprise calibrating the representation of the food item included in the user-supplied image by analyzing a reference item that includes a known approximate size and is depicted in the user-supplied image.

12. The computer memory device of claim 10, wherein the operations further comprise optimizing the representation of the food item included in the user-supplied image by modifying a size of the representation, an alignment of the representation, or a combination thereof.

13. The computer memory device of claim 10, wherein the request to provide the dietary recommendation is generated by a client computing device, which recorded the user-supplied image, and wherein the operations further comprise providing the portion-suggestion image to the client computing device to be rendered.

14. A method of providing dietary recommendations comprising:
receiving a food-item identification that includes a name of a food item and a method of preparing the food item;
determining a total caloric value associated with a reference portion size of the food item when prepared using the method of preparing;
referencing a user profile to retrieve one or more dietary parameters;
using the one or more dietary parameters to calculate a recommended portion size that is a percentage of the reference portion size;
retrieving a stock image that includes a representation of the food item;
generating a graphic that is sized to correlate with the percentage of the reference portion size;
creating a portion-suggestion image including the graphic overlaying the stock image; and
providing the portion-suggestion image to be displayed using a client computing device.

15. The method of claim 14, wherein the one or more dietary parameters includes a calorie allotment assigned to at least a portion of a meal or a snack.
